(19) United States
(12) Patent Application Publication
(10) Pub. No.: US 2018/0096306 A1
(43) Pub. Date: Apr. 5, 2018

(54) IDENTIFYING A SKILL GAP BASED ON MEMBER PROFILES AND JOB POSTINGS

(71) Applicant: LinkedIn Corporation, Mountain View, CA (US)

(72) Inventors: Qin Iris Wang, Cupertino, CA (US); Mohammad H. Firooz, Fremont, CA (US); Link Gan, San Francisco, CA (US); Feng Guo, Los Gatos, CA (US)

(21) Appl. No.: 15/281,713

(22) Filed: Sep. 30, 2016

(51) Int. Cl. G06Q 10/10; G06Q 50/00; G06F 17/27

(52) U.S. Cl. CPC G06Q 10/1053; G06F 17/2705; G06Q 50/01

(57) ABSTRACT

Systems and methods for analyzing job listing data and member profile data to identify in demand skills is disclosed. A computer system receives a request for recommended job listings from a client device. The system accesses a plurality of job listings from a database. The system parses each of the job listings of the plurality of job listings to identify a list of skills required by each job listing. The system accesses a plurality of member profiles. The system analyzes the plurality of member profiles to extract a list of skills from each member profile. For a particular skill in the list of skills, the system calculates a first number of job listings requiring the particular skill and a first number of members who possess the particular skill. The system determines a skill gap value for the particular skill based on the number of job listings requiring that particular skill and the number of members who possess that particular skill.

### TECHNICAL FIELD

The disclosed example embodiments relate generally to the field of data analytics and, in particular, to analyzing profiles and using data analytics to identify trends in the data.

### BACKGROUND

The rise of the computer age has resulted in increased access to personalized services online. As the cost of electronics and networking services drops, many services can be provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly.

Another service provided over networks is social networking. Large social networks allow members to connect with each other and share information. One such type of information is information about available jobs.

Social networks enable members to share and view information about job openings to and from a wide variety of potential markets. In addition, social networks allow a member's social network to influence the type of job opportunities they see and how they evaluate those opportunities. Job openings can be listed by employers and shared with interested members of the social networking system.

### DESCRIPTION OF THE DRAWINGS

Some example embodiments are illustrated by way of example and not limitation in the figures of the accompanying drawings.

FIG. 1 is a network diagram depicting a client-server system that includes various functional components of a social networking system, in accordance with some example embodiments.

FIG. 2 is a block diagram illustrating a client system, in accordance with some example embodiments.

FIG. 3 is a block diagram illustrating a social networking system, in accordance with some example embodiments.

FIG. 4 is a block diagram of a data structure for member profile data for storing member profiles in accordance with some example embodiments.

FIGS. 5A-5B are user interface diagrams illustrating an example of a user interface or web page that incorporates a ranked list of geographic areas recommended to a member during a job search through a social networking system, in accordance with some example embodiments.

FIG. 6 is a flow diagram illustrating a method, in accordance with some example embodiments, for calculating skill gap data and using it to make recommendations to members of a social networking system.

FIG. 7 is a flow diagram illustrating a method, in accordance with some example embodiments, for calculating skill gap data and using it to make recommendations to members of a social networking system.

FIGS. 8A-8E are flow diagrams illustrating a method, in accordance with some example embodiments, for determining a skill gap score for skills based on member profiles and job postings stored at a social networking system.

FIG. 9 is a block diagram illustrating an architecture of software, which may be installed on any of one or more devices, in accordance with some example embodiments.

FIG. 10 is a block diagram illustrating components of a machine, according to some example embodiments.

Like reference numerals refer to corresponding parts throughout the drawings.

### DETAILED DESCRIPTION

The present disclosure describes methods, systems, and computer program products for determining a skill gap score for skills based on member profiles and job postings. In the following description, for purposes of explanation, numerous specific details are set forth to provide a thorough understanding of the various aspects of different example embodiments. It will be evident, however, to one skilled in the art, that any particular example embodiment may be practiced without all of the specific details and/or with variations, permutations, and combinations of the various features and elements described herein.

In some example embodiments, a social networking system has a plurality of members. Each member has an associated member profile. The member profile for each member includes, among other things, one or more skills that the member has. For example, a member profile might list Hadoop, CSS, and Javascript skills for an associated member. In some example embodiments, skills are explicitly indicated by the member. In other example embodiments, other information in the member history can be parsed to infer member skills (e.g., work history, educational history, and so on).

Additionally, the social networking system can include a plurality of job listings that are available to be viewed by members of the social networking system. The job listings can be submitted by members of the social networking system, an organization, a recruiter, or other party interested in hiring members. Each job listing includes a description of the job and any requirements. The text of the listing can be parsed and the skills (or skills groups) required in each listing are determined.

Once the skills that members have are determined, and the skills required by job listings are determined and totaled, the social networking system can compare the two numbers and determine whether there are any significant skill gaps. A skill gap exists when the demand for a particular skill (based on recent job listings) exceeds a determined supply of members who have the skill and are able or willing to fill the job. In some example embodiments, members who have the skill but are unlikely to take the job are not considered when calculating the supply. For example, if the job listing would be a demotion or is in an area remote from a particular member, the particular member will be determined to be an unlikely candidate for the job listing.

Once the social networking system determines a skill gap, that information can be used in a variety of ways. For example, the social networking system can store historic skill gap information. Using historic skill gap information, the social networking system can compare current skills gaps with past skills gaps. Based on this comparison, the social networking system can estimate potential trends in the workforce. For example, if Skill A has a skill gap that has doubled in the last six month, the social networking system can recommend that members acquire that skill. Similarly, this trend information can be used by educational institutions to plan a curriculum.

In some example embodiments, the social networking system can associate job listings and members with particular geographic locations. For example, when a job listing is submitted, the job listing will usually include a particular location where the job is to be performed. Similarly, each member has a current residence location in their profile data. Based on this geographic information, the social networking system can generate country, state (or province), region, or city specific skill gaps. For example, City A has a very different set of skills required (e.g., a manufacturing base) than City B, which has a skill set associated with the oil industry. As such, the skills gaps in City A and City B may be very different.

Thus, when a member begins searching for a job, the social networking system can determine, based on the member's specific skills, one or more geographic areas that have the highest likelihood of hiring someone with those skills. Similarly, if an organization is hiring people with a particular skill or skill group, the social networking system can identify one or more geographic areas where members with those skills are in higher supply.

In some example embodiments, when parsing a job listing, the social networking system identifies a skill name. The social networking system determines, for the skill name, whether that skill name is currently listed in a hierarchical listing of skills or skill groups. If so, the social networking system increases by one the number of job listings that request that skill. If not, the social networking system updates the hierarchical listing of skills to include the skill. In some example embodiments, the skill is added to an existing skill group.

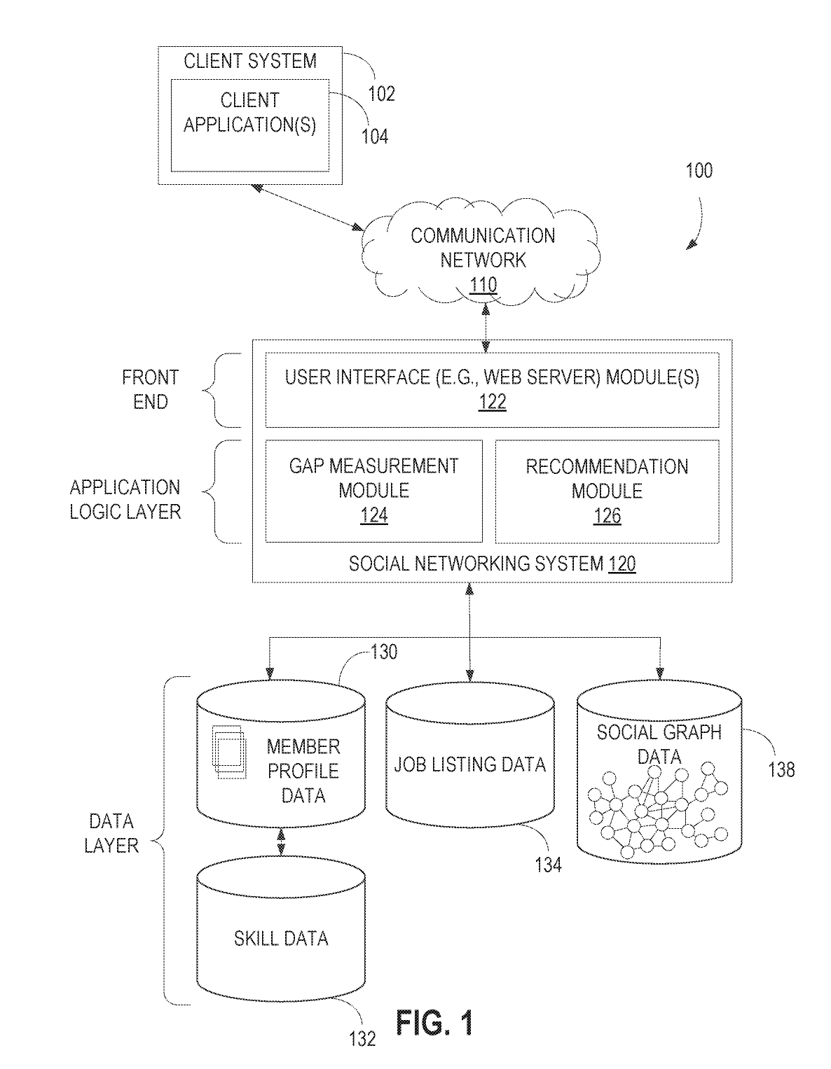

FIG. 1 is a network diagram depicting a client-server system environment 100 that includes various functional components of a social networking system 120, in accordance with some example embodiments. The client-server system environment 100 includes one or more client systems 102 and the social networking system 120. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, the client system 102 is an electronic device, such as a personal computer (PC), a laptop, a smartphone, a tablet, a mobile phone, or any other electronic device capable of communication with the communication network 110. The client system 102 includes one or more client applications 104, which are executed by the client system 102. In some example embodiments, the client application(s) 104 include one or more applications from a set consisting of search applications, communication applications, productivity applications, game applications, word processing applications, or any other useful applications. The client application(s) 104 include a web browser. The client system 102 uses a web browser to send and receive requests to and from the social networking system 120 and to display information received from the social networking system 120.

In some example embodiments, the client system 102 includes an application specifically customized for communication with the social networking system 120 (e.g., a LinkedIn iPhone application). In some example embodiments, the social networking system 120 is a server system that is associated with one or more services.

In some example embodiments, the client system 102 sends a request to the social networking system 120 for skill rankings for one or more skills. For example, a member of the social networking system 120 uses the client system 102 to log into the social networking system 120 and request that a particular set of skills be ranked based on a determined skill gap. In response, the client system 102 receives the ranked list of skills from the social networking system 120 and displays that ranked list of skills in a user interface on the client system 102.

In some example embodiments, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various example embodiments have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although the social networking system 120 is depicted in FIG. 1 as having a three-tiered architecture, the various example embodiments are by no means limited to this architecture.

As shown in FIG. 1, the front end consists of a user interface module(s) (e.g., a web server) 122, which receives requests from various client systems 102 and communicates appropriate responses to the requesting client systems 102. For example, the user interface module(s) 122 may receive requests in the form of Hypertext Transfer Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, skill data 132, job listing data 134, and social graph data 138, which is data stored in a particular type of database that uses graph structures with nodes, edges, and properties to represent and store data. Of course, in various alternative example embodiments, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some example embodiments, when a person initially registers to become a member of the social networking system 120, the person will be prompted to provide some personal information, such as his or her name, age (e.g., birth date), gender, contact information, home town, address, educational background (e.g., schools, majors, etc.), current job title, job description, industry, employment history, skills, professional organizations, memberships with other online service systems, and so on. This information is stored, for example, in the member profile data 130.

In some example embodiments, the member profile data 130 includes or is associated with the member interaction data. In other example embodiments, the member interaction data is distinct from, but associated with, the member profile data 130. The member interaction data stores information detailing the various interactions each member has through the social networking system 120. In some example embodiments, interactions include posts, likes, messages, adding or removing social contacts, and adding or removing member content items (e.g., a message or like), while others are general interactions (e.g., posting a status update) and are not related to another particular member. Thus, if a given member interaction is directed towards or includes a specific member, that member is also included in the membership interaction record.

In some example embodiments, the member profile data 130 includes skill data 132. In other example embodiments, the skill data 132 is distinct from, but associated with, the member profile data 130. The skill data 132 stores skill data for each member of the social networking system 120. Skill data 132 may include both explicit skills and implicit skills.

In some example embodiments, explicit skills are skills that the member is determined to have based on skill information directly received from the member. For example, a member reports that they have skills in using the C++, Java, PHP, CSS, and Python programming languages. Because the member directly reported these skills, they are considered explicit skills. In some example embodiments, explicit skills are listed on a member's public profile.

In some example embodiments, one or more skills are determined based on an analysis of the non-skill data stored in a member profile. Skills determined in this way are considered implicit skills. Implicit skills are determined or inferred by analysing data stored in a member profile, including but not limited to education, job history, hobbies, friends, skill ratings, interests, projects a member has worked on, activity on the social networking system 120, and member submitted comments. In some example embodiments, implicit skills may also be called inferred skills or skills a member may have. For example, member A lists an undergraduate degree in architecture and has a past job history that includes Project Architect for at least three different projects. Using a table that indicates likely skills for members who have had certain titles, jobs, educational experience, and so on, the social networking system 120 determines that member A has a skill in AutoCAD even though the member has not directly reported having that skill. In some example embodiments, implicit skills are not listed on a member's public profile.

The job listing data 134 stores data related to one or more job listings. Job listings are created in response to a request from a member or organization to list a job opening on the social networking system 120. Job listings include, but are not limited to, the job title, the job role, a description of the job requirements, a description of the job responsibilities, compensation data, skills associated with the job, the organization associated with the job, the specific location of the job, one or more potential evaluators for the job, one or more teams within an organization with which the job is associated, and one or more members who are likely coworkers associated with the job.

Once registered, a member may invite other members, or be invited by other members, to connect via the social networking system 120. A “connection” may include a bilateral agreement by the members, such that both members acknowledge the establishment of the connection. Similarly, in some example embodiments, a member may elect to “follow” another member. In contrast to establishing a “connection,” the concept of “following” another member typically is a unilateral operation and, at least in some example embodiments, does not include acknowledgement or approval by the member that is being followed. When one member follows another, the member who is following may receive automatic notifications about various interactions undertaken by the member being followed. In addition to following another member, a member may elect to follow a company, a topic, a conversation, or some other entity, which may or may not be included in the social graph. Various other types of relationships may exist between different entities, and are represented in the social graph data 138.

The social networking system 120 may provide a broad range of other applications and services that allow members the opportunity to share and receive information, often customized to the interests of the member. In some example embodiments, the social networking system 120 may include a photo sharing application that allows members to upload and share photos with other members. As such, at least in some example embodiments, a photograph may be a property or entity included within a social graph. In some example embodiments, members of the social networking system 120 may be able to self-organize into groups, or interest groups, organized around a subject matter or topic of interest. In some example embodiments, the data for a group may be stored in a database. When a member joins a group, his or her membership in the group will be reflected in the member profile data 130 and the social graph data 138.

In some example embodiments, the application logic layer includes various application server modules, which, in conjunction with the user interface module(s) 122, generate various user interfaces (e.g., web pages) with data retrieved from various data sources in the data layer. In some example embodiments, individual application server modules are used to implement the functionality associated with various applications, services, and features of the social networking system 120. For instance, a messaging application, such as an email application, an instant messaging application, or some hybrid or variation of the two, may be implemented with one or more application server modules. Similarly, a search engine enabling members to search for and browse member profiles may be implemented with one or more application server modules.

A gap measurement module 124 or a recommendation module 126 can also be included in the application logic layer. Of course, other applications or services that utilize the gap measurement module 124 and the recommendation module 126 may be separately implemented in their own application server modules.

As illustrated in FIG. 1, in some example embodiments, the gap measurement module 124 and the recommendation module 126 are implemented as services that operate in conjunction with various application server modules. For instance, any number of individual application server modules can invoke the functionality of the gap measurement module 124 and the recommendation module 126. However, in various alternative example embodiments, the gap measurement module 124 and the recommendation module 126 may be implemented as their own application server modules such that they operate as standalone applications.

Generally, the gap measurement module 124 accesses member skill data stored in the skill data 132. Member skill data for a particular member includes a list of skills (either specific individual skills or a skill group) that the member is determined to possess (e.g., either explicitly or implicitly). The gap measurement module 124 creates a table that organizes skills by group and/or location. Each time a skill is determined to be associated with a member, the table is updated to increment the number of members that have that skill. When the table is divided based on location, when a skill is identified in a member profile, the gap measurement module 124 determines a location associated with the member and only that section of the table is updated.

Similarly, the gap measurement module 124 accesses a job listing from the job listing data 134 stored at the social networking system 120. The gap measurement module 124 then parses the text in each job listing. The text is parsed to determine any skills required by the job listing, the location that the job is associated with, a company associated with the job listing, and any other relevant information.

The gap measurement module 124 creates a table that organizes job listing requirements by group and/or location. Each time a job listing is parsed, all the skills determined to be required by the job listing are used to update the table, such that each time a skill is determined to be required by the job listing, the table listing that represents a count of the listings requiring that skill is incremented.

If the job listings table is divided based on location, the gap measurement module 124 determines a location associated with the particular job listing and updates the appropriate skill in the corresponding job section of the member.

In some example embodiments, the gap measurement module 124 determines the difference between the determined number of job listings that require a particular skill and the number of members who possess that skill. In some example embodiments, the gap measurement module 124 generates a skill gap score for each skill. In some example embodiments, the skill gap score is based on the rate at which job listings are filled. For example, if job listings that require skill A take three months, on average to fill, and job listings that require skill B take two months on average to fill, the skill gap score for skill A will be larger, all other factors being equal.

In some example embodiments, the gap measurement module 124 measures average job stay length to determine a skill gap score for a particular skill. In some example embodiments, if members with Skill C have a shorter average job stay length (the average amount of time at a particular job before starting a new one) and members with skill D have a longer average job stay length, then skill C will have a smaller skill gap score than skill D, all other things being equal.

In some example embodiments, the recommendation module 126 analyzes the skill gap score information to provide recommendations to members, organizations, educational institutions, governmental organizations, and so on.

For example, a member is interested in expanding their skill set by accessing educational opportunities. The member can request a list of recommendations from the recommendation module 126 based on skill gap data. The recommendation module 126 can then transmit a ranked list of skills (or skill groups) to the member. In some example embodiments, the ranked list of skills also includes one or more recommended educational organizations that provide tools to learn the recommended skills.

In some example embodiments, the recommendations are based on the location and field of work for the member. In some example embodiments, the recommendation module 126 uses past skill gap data to determined skill gap trends (e.g., skills that have an increasing skill gap over time as more listings are added but a decreasing proportion of members that possess the skill).

In this way, the recommendation module 126 can produce recommendations based on the expected skill gap for a particular skill in the future based on current trends. In some example embodiments, skill trends can also be determined based on course data from educational institutions. For example, if educational institution A is a leader in a given skill field (e.g., based on third-party data or internal data) the recommendation module 126 can determine what skills are added to the curriculum of the educational institution and how many students take those class. The recommendation module 126 can recommend these skills more highly.

Similarly, an educational institution or government agency can use skill gap data (and skill gap trend data) when planning resource allocation. For example, a government agency can request skill gap rankings for the geographic area of the agency and then use this recommendation information to enact policies to remedy the skill gap. An educational institution can request skill recommendations to inform curriculum planning.

In some example embodiments, an organization, such as a company, that has outstanding job listings can request recommendations for geographic areas from which to recruit members based on skill gap information. For example, if Company A has an outstanding job listing (e.g., a job that has not yet been filled) the organization can request that the recommendation module 126 determine one or more geographic areas where members who have skills required by the job listing either outnumber or are not significantly outnumbered by the number of job listings in that area that require the skill. Using this information, the organization can prioritize their recruiting efforts.

In some example embodiments, a member that is looking for a job can request that the recommendation module 126 identify one or more geographic locations where the skills of the member are in highest demand (e.g., have the largest skill gap score).

In some example embodiments, the recommendation module 126 transmits a list of geographic locations (and potentially one or more job listings associated with each geographic location) to the client system (e.g., the client system 102 in FIG. 1) associated with the member for display.

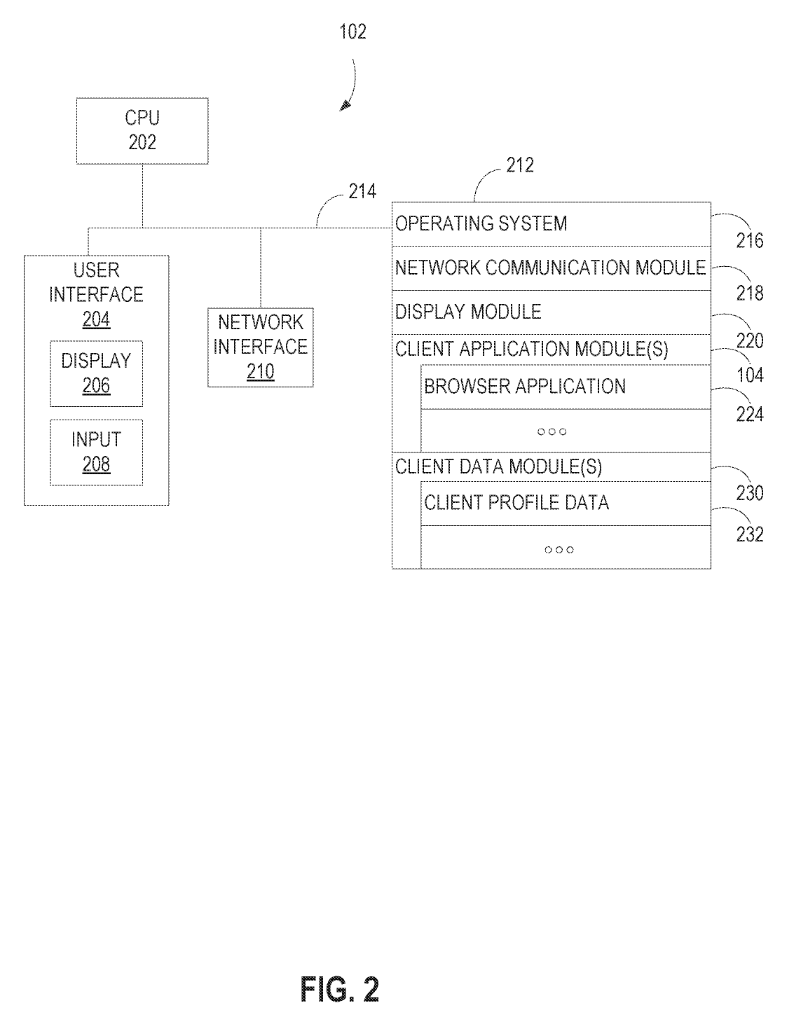

FIG. 2 is a block diagram further illustrating the client system 102, in accordance with some example embodiments. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means 208 such as a keyboard, a mouse, a touch sensitive display, or other input buttons. Furthermore, some client systems 102 use a microphone and voice recognition to supplement or replace the keyboard.

The memory 212 includes high-speed random-access memory, such as dynamic random-access memory (DRAM), static random-access memory (SRAM), double data rate random-access memory (DDR RAM), or other random-access solid state memory devices; and may include non-volatile memory, such as one or more magnetic disk storage devices, optical disk storage devices, flash memory devices, or other non-volatile solid state storage devices. The memory 212 may optionally include one or more storage devices remotely located from the CPU(s) 202. The memory 212, or alternatively, the non-volatile memory device(s) within the memory 212, comprise(s) a non-transitory computer-readable storage medium.

In some example embodiments, the memory 212, or the computer-readable storage medium of the memory 212, stores the following programs, modules, and data structures, or a subset thereof:
an operating system 216 that includes procedures for handling various basic system services and for performing hardware-dependent tasks;
a network communication module 218 that is used for connecting the client system 102 to other computers via the one or more network interfaces 210 (wired or wireless) and one or more communication networks 110, such as the Internet, other WANs, LANs, metropolitan area networks (MANs), etc.;
a display module 220 for enabling the information generated by the operating system 216 and client application(s) 104 to be presented visually on the display device 206;
one or more client applications module(s) 104 for handling various aspects of interacting with the social networking system (e.g., system 120 in FIG. 1), including but not limited to:
   a browser application 224 for requesting information from the social networking system 120 (e.g., skills gap rankings) and receiving responses from the social networking system 120; and
client data module(s) 230 for storing data relevant to clients, including but not limited to:
   client profile data 232 for storing profile data related to a member of the social networking system 120 associated with the client system 102.

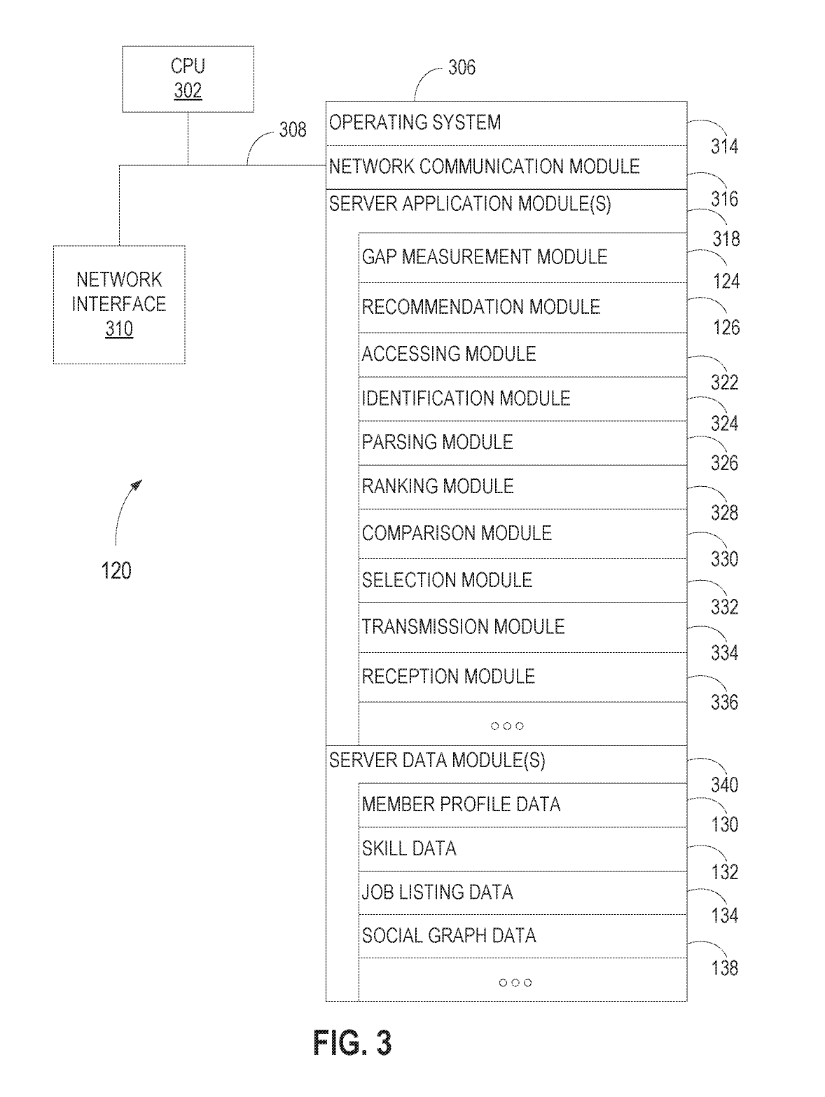

FIG. 3 is a block diagram further illustrating the social networking system 120, in accordance with some example embodiments. Thus, FIG. 3 is an example embodiment of the social networking system 120 in FIG. 1. The social networking system 120 typically includes one or more CPUs 302, one or more network interfaces 310, memory 306, and one or more communication buses 308 for interconnecting these components. The memory 306 includes high-speed random-access memory, such as DRAM, SRAM, DDR RAM, or other random-access solid state memory devices; and may include non-volatile memory, such as one or more magnetic disk storage devices, optical disk storage devices, flash memory devices, or other non-volatile solid state storage devices. The memory 306 may optionally include one or more storage devices remotely located from the CPU(s) 302.

The memory 306, or alternatively the non-volatile memory device(s) within the memory 306, comprises a non-transitory computer-readable storage medium. In some example embodiments, the memory 306, or the computer-readable storage medium of the memory 306, stores the following programs, modules, and data structures, or a subset thereof:
an operating system 314 that includes procedures for handling various basic system services and for performing hardware-dependent tasks;
a network communication module 316 that is used for connecting the social networking system 120 to other computers via the one or more network interfaces 310 (wired or wireless) and one or more communication networks 110, such as the Internet, other WANs, LANs, MANs, and so on;
one or more server application modules 318 for performing the services offered by the social networking system 120, including but not limited to:
   a gap measurement module 124 for determining, based on job listings and member profiles, the number of jobs requiring a given skill and the number of members who currently have that skill in each particular geographic area;
   a recommendation module 126 for ranking one or more skills based on a skill gap score or ranking a geographic area based on a skill gap score associated with that area;
   an accessing module 322 for accessing skill data 132 in member profiles and job listings included in the job listing data 134;
   an identification module 324 for identifying one or more distinct geographic regions (including cities, states, provinces, regions, countries, continents, and so on) from a job listing or member profile;
   a parsing module 326 for parsing a job listing to determine one or more skills required by the job listing and a location associated with the job listing;
   a ranking module 328 for ranking skills or geographic locations based on a determined skill gap;
   a comparison module 330 for comparing current skill gap scores to past skill gap scores to determine trends within the skill gap data;
   a selection module 332 for selecting one or more skills or geographic locations based on the ranking data generated by the ranking module 328;
   a transmission module 334 for transmitting a selected skill or geographic location to a client system (e.g., the client system 102 in FIG. 1) for display; and
   a reception module 336 for receiving a selection of a skill or educational opportunity from a client system (e.g., the client system 102 in FIG. 1); and
server data module(s) 340, holding data related to the social networking system 120, including but not limited to:
   member profile data 130, including both data provided by the member, who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on the member's activity, social graph data 138, overall trend data for the social networking system 120, and so on;
   skill data 132 including data representing a member's stated or inferred skills;
   job listing data 134 including data describing one or more job opportunities including a source organization, one or more required skills, a job title, a location, a team name, a compensation amount, a list of responsibilities and requirements, and so on; and
   social graph data 138 including data that represents members of the social networking system 120 and the social connections between them.

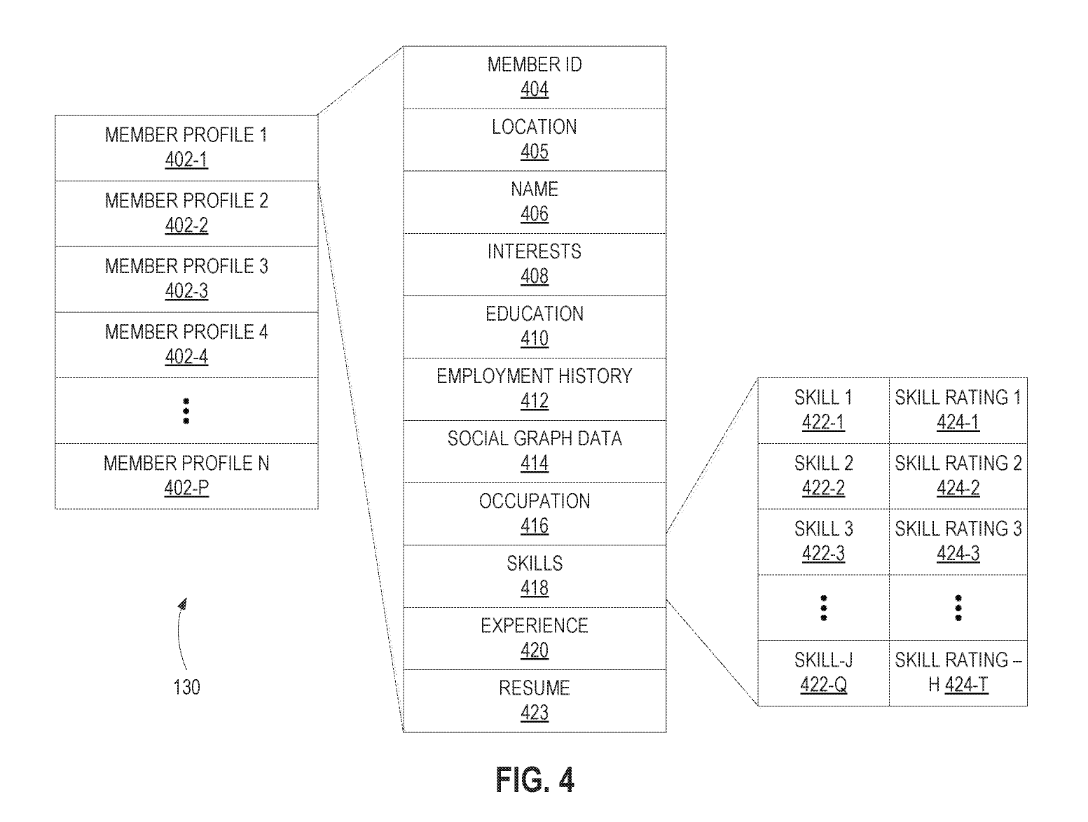

FIG. 4 is a block diagram of a data structure for the member profile data 130 for storing member profiles in accordance with some example embodiments. In one embodiment, the member profile data 130 includes a plurality of member profiles 402-1 to 402-P, each of which corresponds to a member of the social networking system 120.

In some example embodiments, a respective member profile 402 stores a unique member ID 404 for the member profile 402, a location associated with the member (e.g., the location that the member indicated was their location), a name 406 for the member (e.g., the member's legal name), member interests 408, member education history 410 (e.g., the high school and universities the member attended and the subjects studied, online courses or certifications, licenses, and so on), employment history 412 (e.g., member's past and present work history with job titles), social graph data 414 (e.g., a listing of the member's relationships as tracked by the social networking system 120), occupation 416, skills 418, experience 420 (for listing experiences that don't fit under other categories, like community service or serving on the board of a professional organization), and a detailed member resume 423.

In some example embodiments, a member profile 402 includes a list of skills (422-1 to 422-Q) and associated skill ratings (424-1 to 424-T). Each skill 422 represents a skill or ability that the member associated with the member profile 402 has. For example, a computer programmer might list FORTRAN as a skill. In addition, each skill has an associated skill rating 424. In some example embodiments, a skill rating 424 represents the social networking system's 120 estimation of the member's proficiency in a skill, based on endorsements and feedback from other members, feedback on articles and posts by the member, a members social contacts, and so on. For example, if a member has a high number of endorsements from other members for a particular skill (especially from members that also possess the particular skill) that member's skill rating 424 for the associated particular skill will be higher that a similar member with few or no recommendations.

For example, the skill rating 424 could be a number from 1 to 100 wherein 100 represents the highest level of skill and 1 represents the lowest. Thus, a member who had AutoCAD with a skill rating of 25 would be less proficient using AutoCAD than a member with a skill rating of 78.

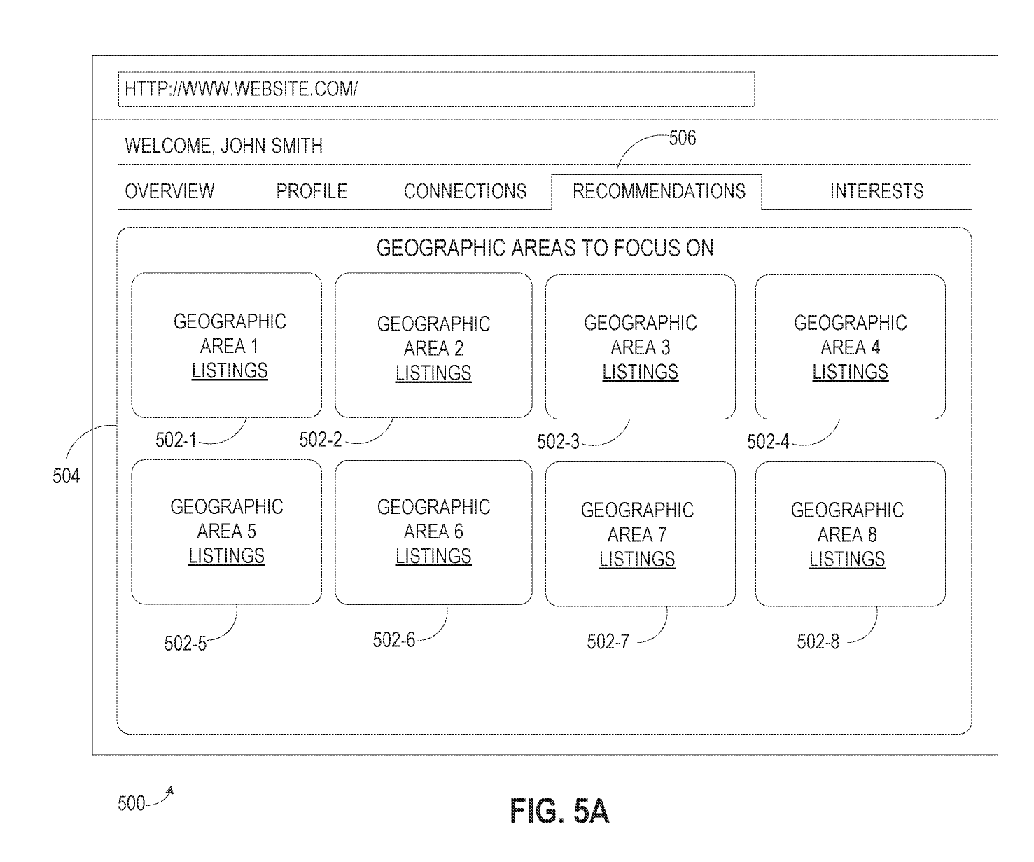

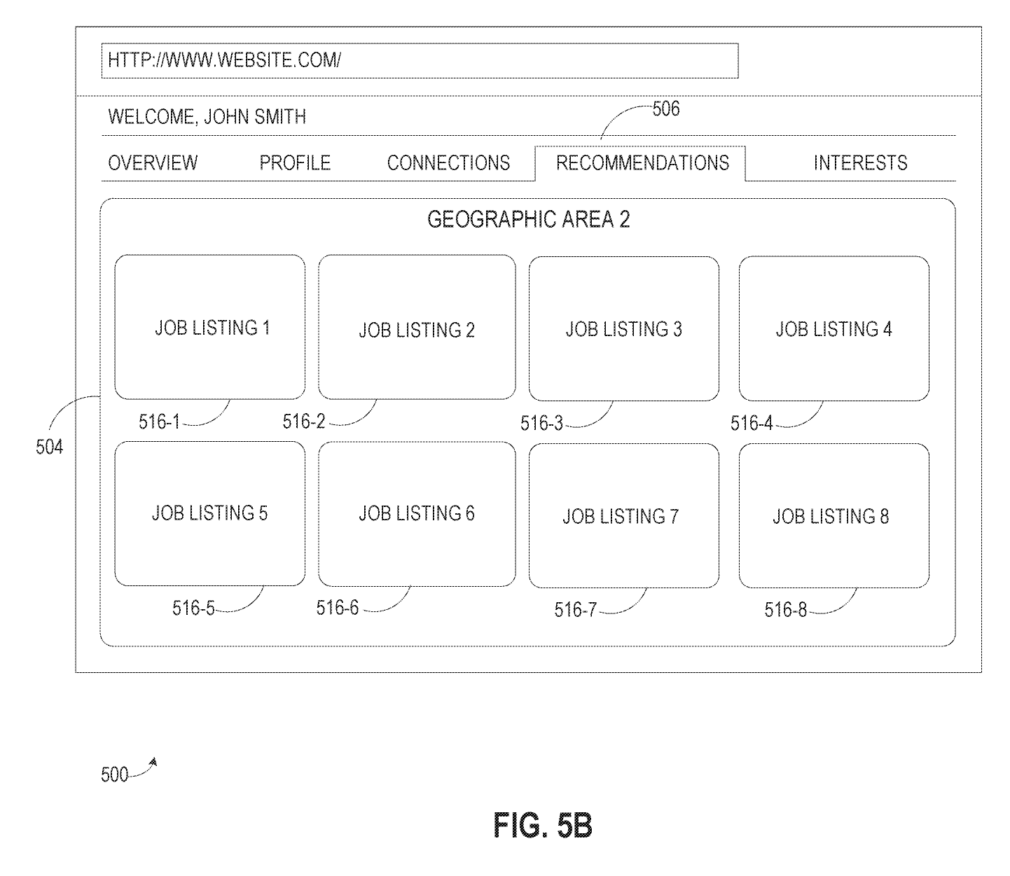

FIG. 5A is a user interface diagram illustrating an example of a user interface 500 or web page that incorporates a ranked list of geographic areas recommended to a member during a job search through a social networking system (e.g., the social networking system 120 in FIG. 1). In the example user interface 500 of FIG. 5A, the displayed user interface 500 represents a web page for a member of the social networking system (e.g., the social networking system 120 in FIG. 1) with the name John Smith.

As can be seen, a recommendations tab 506 has been selected and a page of relevant geographic areas 504 is displayed. The geographic areas 504 are determined based on the skills possessed by the requesting member and the skill gap data associated with each geographic area. Specifically, geographic areas that have large skills gaps for skills possessed by the requesting member are more likely to be recommended. Each geographic area 502-1 to 502-8 displays a link to job listings associated with the specific geographic areas 504. In some example embodiments, the requesting member can select a particular skill to use when evaluating the skills gaps of geographic areas.

FIG. 5B is a user interface diagram further illustrating an example of the user interface 500 or web page that reflects the changes in the web page that occur when a member selects a particular geographic area from the list of geographic areas 504 in FIG. 5A. The example user interface 500 of FIG. 5B represents a continuation from FIG. 5A.

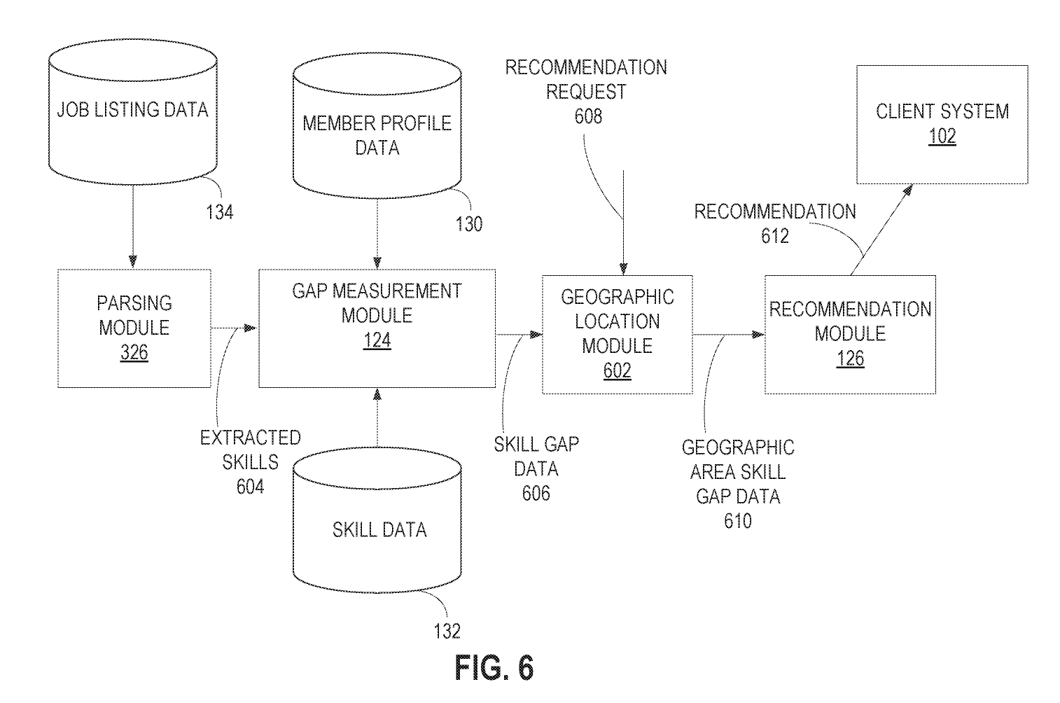

In response to selection for one or more job listings of a particular geographic area, the social networking system (e.g., the social networking system 120 in FIG. 1) identifies a list of job listings 516-1 to 516-8 appropriate for the member based on the member's skills and the skill gap for the selected geographic area. The job listings 516-1 to 516-8 are selected in the manner described below in the description accompanying FIGS. 6, 7, and 8A-8E and are then communicated to the member for his or her review.

FIG. 6 is a block diagram illustrating a system, in accordance with some example embodiments, for calculating skill gap data and using it to make recommendations to members of a social networking system (e.g., the social networking system 120 in FIG. 1). In some example embodiments, the system is depicted as a functional diagram of modules and data stores.

In some example embodiments, a parsing module 326 accesses job listings from job listing data 134 stored at the social networking system (e.g., the social networking system 120 in FIG. 1). In some example embodiments, each job listing is received from a third party (e.g., an organization) and recorded in job listing data 134.

The parsing module 326 then parses the content of the job listing (e.g., a textual description of the job) to extract data about the job listing to a format useable by the social networking system (e.g., the social networking system 120 in FIG. 1). For example, the parsing module 326 determines the title of the job, the organization (e.g., company) that provides the job, a list of the skills required by the job, the benefits associated with the job, the experience and seniority required by the job, any educational requirements, and so on.

The parsing module 326 then transfers the list of required skills from each the parsed job listings to the gap measurement module 124. In some example embodiments, the gap measurement module 124 then accesses member profile data 130 and skill data 132 to identify a list of skills possessed by each member. As noted above, the list of skills includes skills explicitly claimed by the member and skills inferred based on other data included in the member profile data 130.

In some example embodiments, the gap measurement module 124 counts the total number of members who possess a particular skill and compares it to the number of job listings that require the skill. For each skill, a skill gap score is determined based on that comparison. In some example embodiments, the skill cap score is a comparison between the two numbers (e.g., subtract the number of members who have the skill from the number of job listings that require the skill). In other example embodiments, the skill gap score is a ratio of members who have the skill to job listings that require the skill.

In some example embodiments, each member is classified based on the likelihood that they are looking for a new job. For example, members who are unemployed are determined to have a high likelihood of looking for a new job and members who have very recently started a new job or educational program (e.g., within the last 3 months) will be determined to have a relatively low likelihood of looking for a new job. In other example embodiments, the likelihood is calculated based on the current length of employment, the member's specific history of job changes, and average job length in the specific role, industry, and location of the member.

When calculating the total number of members who are available with a particular skill, each member is then weighted based on the likelihood that the member will be available in the job market to fill a job listing in the near future (e.g., within the next quarter). This weighted skill supply score is then used to more accurately determine the skill gap score for a particular skill. An example of determining the weighted skill supply score is:

SupplyScore=m1*w1+m2*w2+ . . . mN*wN

Thus, the supply score is determined by summing the number of members (m1, m2, . . . mN) who have the skill, each of which is weighted by the likelihood that the member would take a new job (w1, w2, . . . wN).

In some example embodiments, skill gap data 606 for each skill is transmitted from the gap measurement module 124 to the geographic location module 602 in response to receiving a recommendation request 608 from a client system (e.g., the client system 102 in FIG. 1).

In some example embodiments, the geographic location module 602 then identifies a plurality of geographic locations. In some example embodiments, the geographic locations are arranged in a hierarchy from largest geographic location (e.g., the entire world) to progressively smaller geographic locations (e.g., continent, region, country, city, and so on). For each geographic location, a geographic location-specific skill gap score is determined (e.g., a skill gap score that only considers members and job listings associated with the particular geographic region). In some example embodiments, the geographic location-specific skill gap scores are generated by the gap measurement module 124.

In some example embodiments, the received recommendation request 608 is a request for job listings for a particular member. In this case, the gap measurement module 124 identifies job listings with high skill gaps for the member's skills in the member's area. In other example embodiments, the received recommendation request 608 is a request from an organization to identify members or geographic locations to focus recruiting attention for a particular job or job type.

In some example embodiments, the request is from a member and requests to identify geographic areas with large skill gaps in a particular skill (wherein the recommendation request 608 identifies a particular skill). In some example embodiments, the appropriate geographic area skill gap data 610 is transmitted to a recommendation module 126.

In some example embodiments, the recommendation module 126 uses the received geographic area skill gap data 610, with other information, to identify information responsive to a recommendation request 608. Thus, if the recommendation request 608 is for skill-appropriate job listings, the recommendation module 126 will provide job listing recommendations 612. In some example embodiments, the recommendation request 608 seeks identification of a particular geographic area with a desired skill gap.

In some example embodiments, the recommendations 612 are transmitted to the client system (e.g., the client system 102 in FIG. 1) for display. In some example embodiments, this results in the social networking system (e.g., the social networking system 120 in FIG. 1) sending data to be displayed (e.g., the job listings and any needed web page elements) and instructions that cause the data to be presented on a display device at the client system (e.g., the client system 102 in FIG. 1).

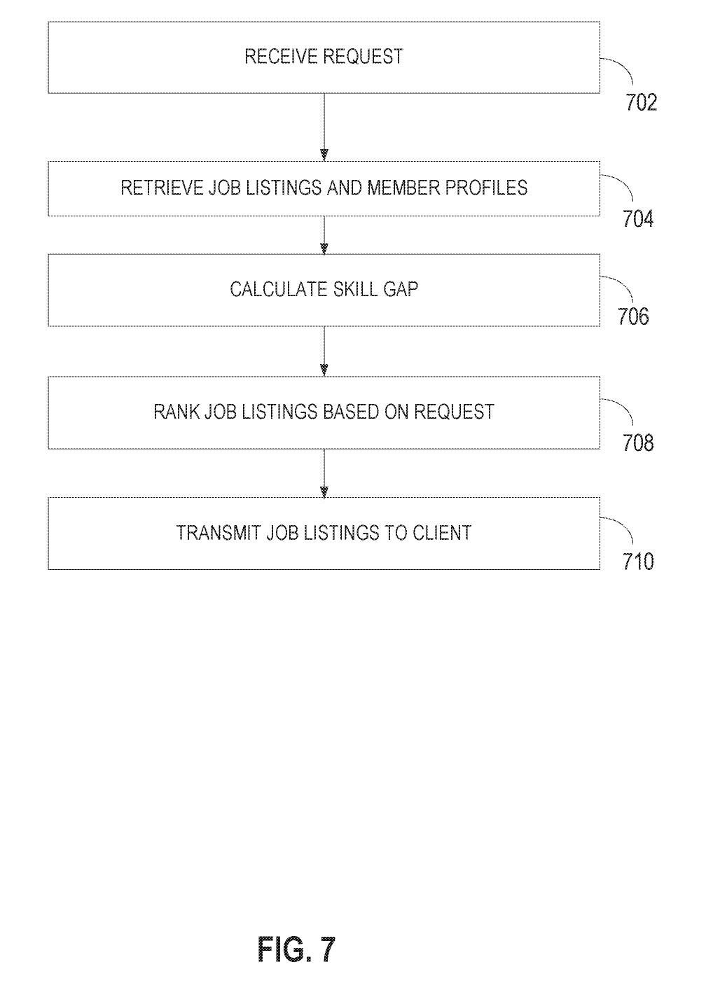

FIG. 7 is a flow diagram illustrating a method, in accordance with some example embodiments, for calculating skill gap data and using it to make recommendations to members of a social networking system (e.g., the social networking system 120 in FIG. 1). Each of the operations shown in FIG. 7 may correspond to instructions stored in a computer memory or computer-readable storage medium. In some embodiments, the method described in FIG. 7 is performed by the social networking system (e.g., the social networking system 120 in FIG. 1). However, the method described can also be performed by any other suitable configuration of electronic hardware.

In some embodiments the method is performed by a social networking system (e.g., the social networking system 120 in FIG. 1) including one or more processors and memory storing one or more programs for execution by the one or more processors.

In some example embodiments, the social networking system (e.g., the social networking system 120 in FIG. 1) receives (702) a request from a client system (e.g., the client system 102 in FIG. 1). In some example embodiments, the client system (e.g., the client system 102 in FIG. 1) requests job listings at least partially sorted based on the skill gap associated with a given member's skill set. For example, a member requests a list of job listings that require skills that have skill gap scores that are above a threshold and are possessed by the member.

In response to receiving the request, the social networking system (e.g., the social networking system 120 in FIG. 1), retrieves (704) a plurality of job listings and member profiles. In some example embodiments, the job listings and member profiles are stored at a database at the social networking system (e.g., the social networking system 120 in FIG. 1). In some example embodiments, the member profiles include a list of skills which the member possesses.

In some example embodiments, the job listings are parsed to ensure that the skill requirements (e.g., the skills necessary to qualify for the job in the job listing) are in a data format that is useable to determine a list of skills required by each job. Thus, plain text (e.g., prose describing the job requirements) is analyzed by a text parser and a list of required skills are extracted. Parsing includes identifying key words and matching the keywords to skills.

In some example embodiments, the social networking system (e.g., the social networking system 120 in FIG. 1) totals the number of job listings that require a particular skill and also totals the number of members who have the particular skill. Using these two totals, the social networking system (e.g., the social networking system 120 in FIG. 1) calculates a skill gap score for each skill in the plurality of skill scores.

In some example embodiments, the social networking system (e.g., the social networking system 120 in FIG. 1) ranks (708) job listings based on the received request. For example, if the request is for job listings from areas with a high skill gap for a particular skill, the social networking system (e.g., the social networking system 120 in FIG. 1) will rank job listings based on the degree to which they match the criteria laid out in the request.

In some example embodiments, the social networking system (e.g., the social networking system 120 in FIG. 1) transmits (710) the top ranked job listings to the client system (e.g., the client system 102 in FIG. 1). In some example embodiments, the transmitted data causes the job listings to be displayed on a display device associated with the client system (e.g., the client system 102 in FIG. 1).

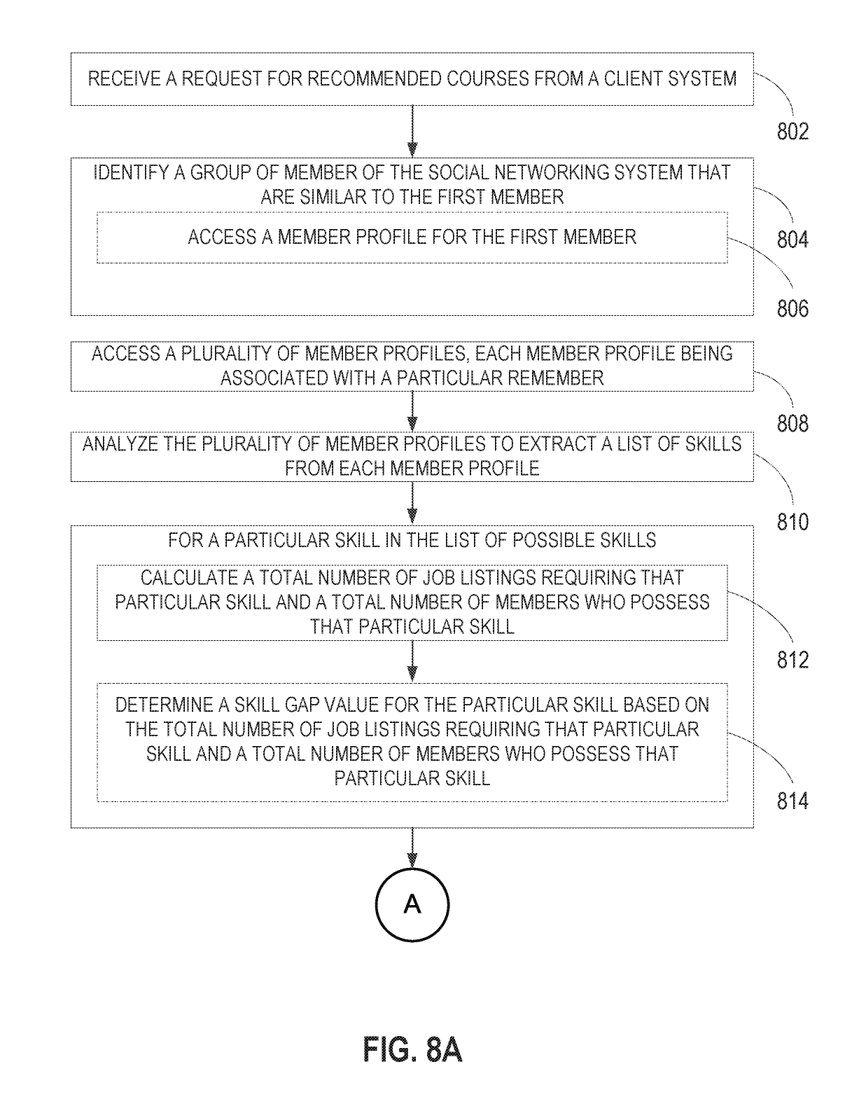

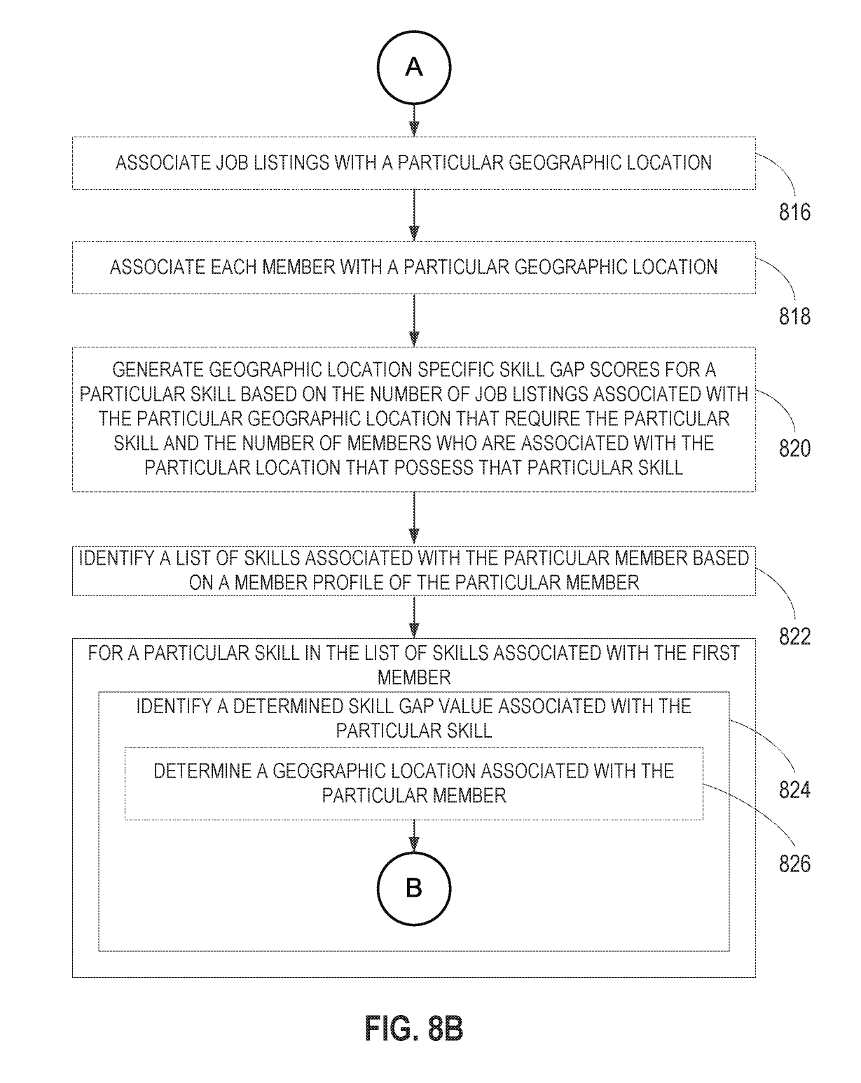

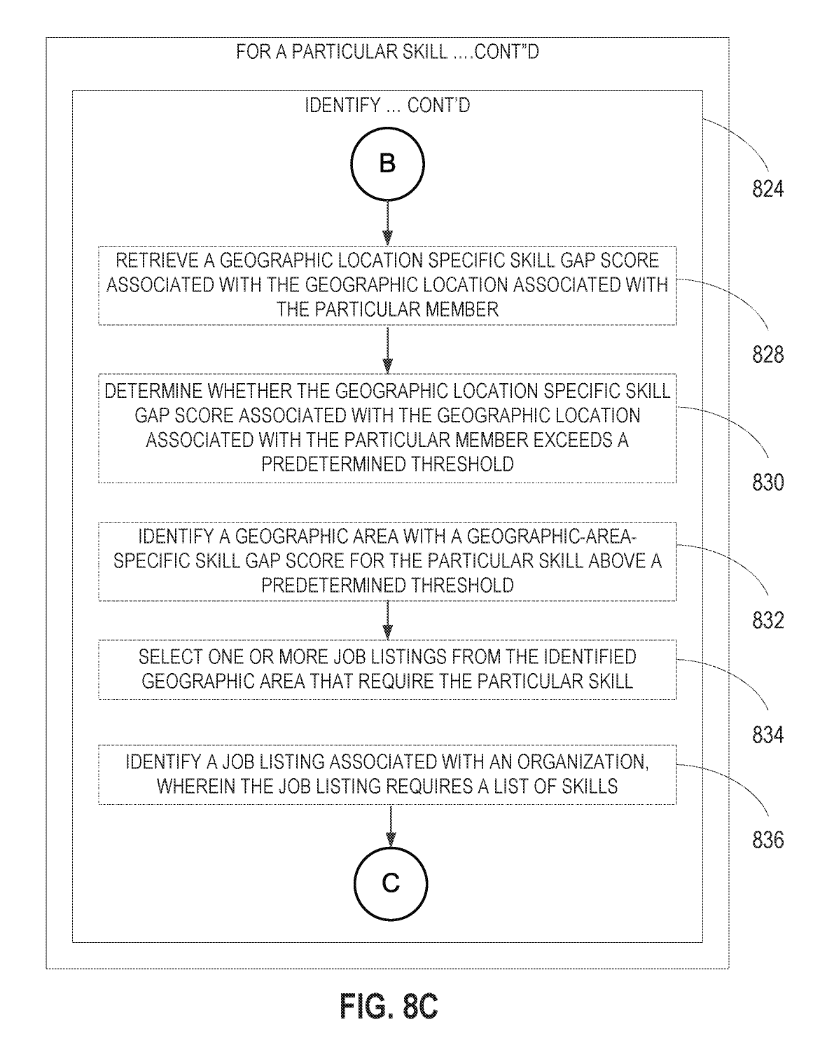

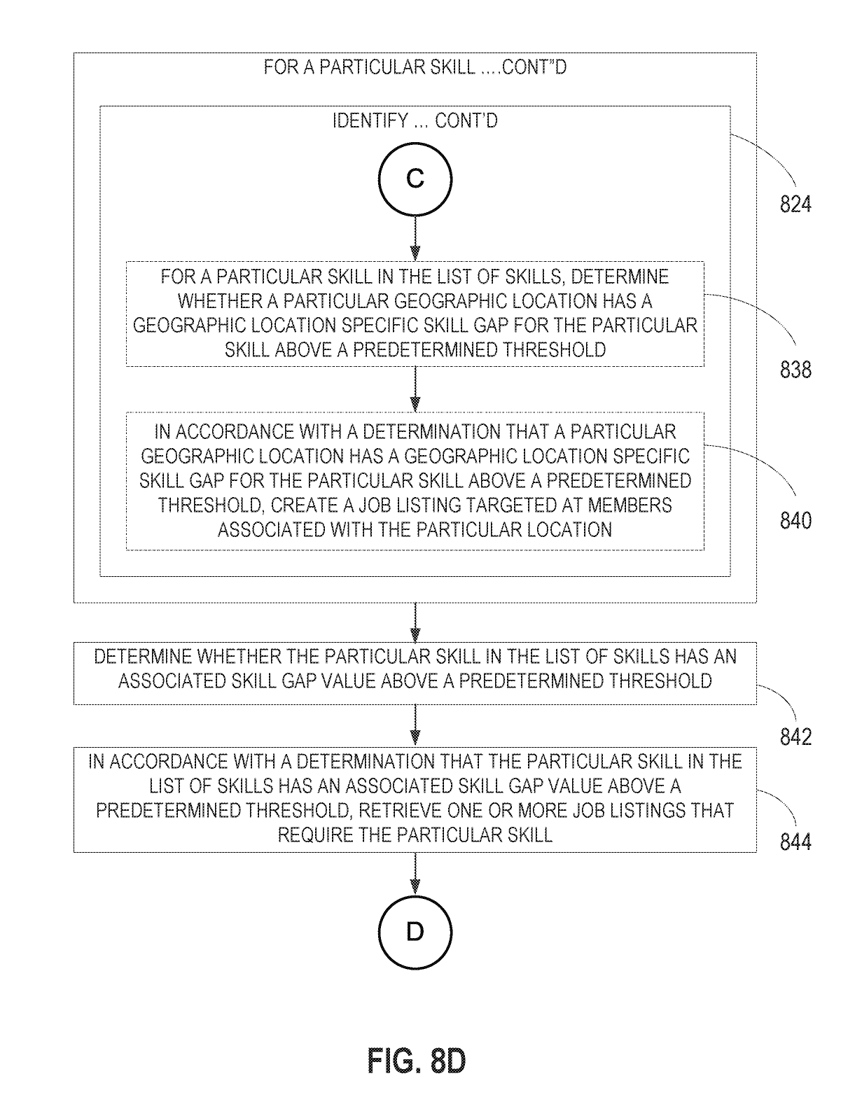

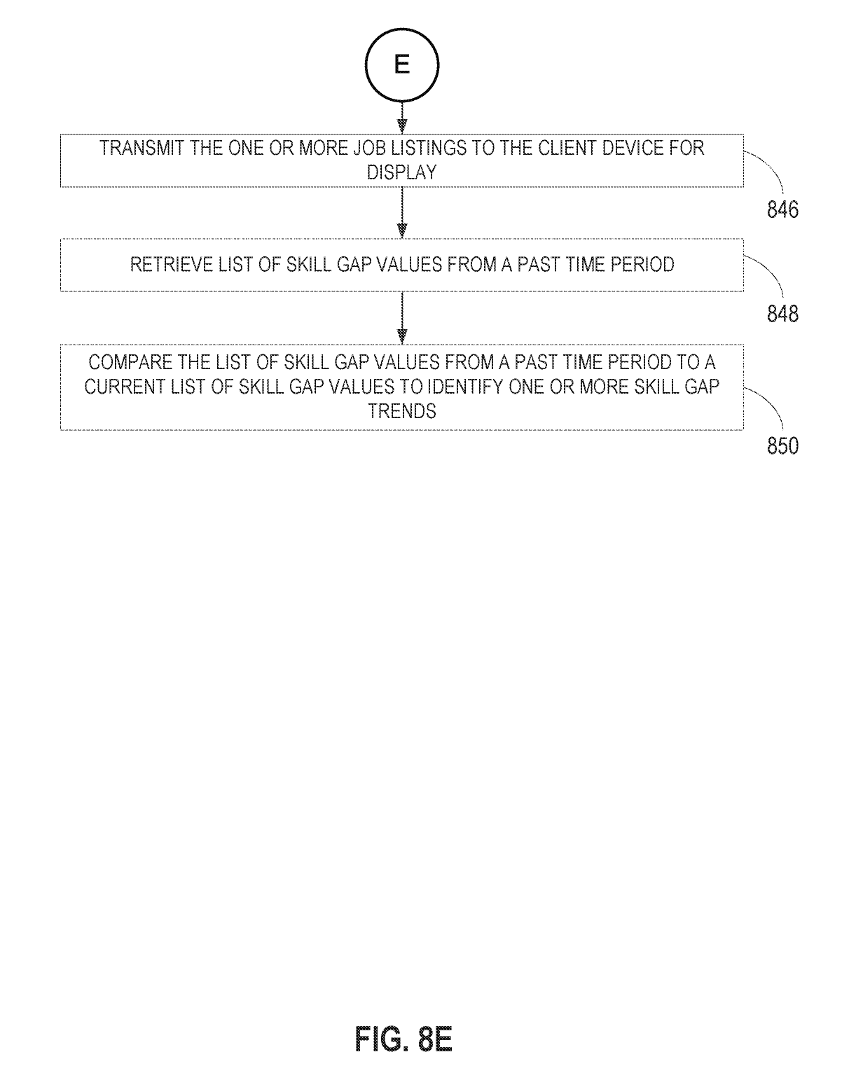

FIG. 8A is a flow diagram illustrating a method, in accordance with some example embodiments, for determining a skill gap score for skills based on member profiles and job postings stored at a social networking system (e.g., the social networking system 120 in FIG. 1). Each of the operations shown in FIG. 8A may correspond to instructions stored in a computer memory or computer-readable storage medium. Optional operations are indicated by dashed lines (e.g., boxes with dashed-line borders). In some embodiments, the method described in FIG. 8A is performed by the social networking system (e.g., the social networking system 120 in FIG. 1). However, the method described can also be performed by any other suitable configuration of electronic hardware.

In some embodiments the method is performed by a social networking system (e.g., the social networking system 120 in FIG. 1) including one or more processors and memory storing one or more programs for execution by the one or more processors.

In some example embodiments, the social networking system (e.g., the social networking system 120 in FIG. 1) receives (802) a request for recommended job listings from a client device. In some example embodiments, the request is associated with a first member of a social networking system (e.g., the social networking system 120 in FIG. 1). In some example embodiments, a plurality of different request types can be received by the social networking system (e.g., the social networking system 120 in FIG. 1). For example, a specific member can request job listings that are specifically suited to the skills the member has.

Specifically, the request from the member could request that the social networking system (e.g., the social networking system 120 in FIG. 1) determine which of the requesting member's skill have a skill gap over a threshold. In some example embodiments, the threshold is predefined by the social networking system (e.g., the social networking system 120 in FIG. 1). In other example embodiments, the member can indicate a desired threshold in the request itself. For example, the member can request that the threshold be one of several skill gap ranges such as “low skill gap,” “medium skill gap,” or “high skill gap.”

In other example embodiments, the request is from an organization with outstanding job needs and requests the social networking system (e.g., the social networking system 120 in FIG. 1) to identify one or more geographic areas with skill gap scores that represent a high level of available members with the particular skills needed to fill the job needs. In other example embodiments, a member requests the social networking system (e.g., the social networking system 120 in FIG. 1) to identify geographic areas with relative high skill gap scores for skills the member possesses and to retrieve job listings for that area. In this way, a member can identify geographic areas with high need for their skills.

In some example embodiments, in response to receiving the request, the social networking system (e.g., the social networking system 120 in FIG. 1) accesses (804) a plurality of job listings from a database at the social networking system. In some example embodiments, each job listing includes a list of information about the job, including, but not limited to, the job title, the duties required of the person, the job location, information about job benefits, skills required, educational history, seniority, and so on. In some example embodiments, the job listings are written in plain text (as opposed to structured data) and are stored in a database at the social networking system (e.g., the social networking system 120 in FIG. 1).

In some example embodiments, the job listings are submitted by organizations and stored in a database of the social networking system. For example, a company with job openings can submit those job listings to the social networking system (e.g., the social networking system 120 in FIG. 1) and make them accessible to members of the social networking system (e.g., the social networking system 120 in FIG. 1).

In some example embodiments, the social networking system (e.g., the social networking system 120 in FIG. 1) parses (806) the plurality of job listings to identify a list of skills required by each job listing. Thus the social networking system (e.g., the social networking system 120 in FIG. 1) uses natural language processing techniques (of which there are many) to extract a list of required (or desired) skills from a text description of the requirements of the job.

In some example embodiments, the social networking system (e.g., the social networking system 120 in FIG. 1) accesses (808) a plurality of member profiles, each member profile being associated with a particular remember. For example, when a member signs up with the social networking system (e.g., the social networking system 120 in FIG. 1), a member record for that member is created that includes the member's name, age, geographic information, work history, skills, educational history, and so on.

In some example embodiments, the social networking system (e.g., the social networking system 120 in FIG. 1) analyzes (810) the plurality of member profiles to extract a list of skills from each member profile. For example, a member profile includes a list of skills that the member has indicated that they possess and also one or more skills that the social networking system (e.g., the social networking system 120 in FIG. 1) can infer that the member possesses. The social networking system (e.g., the social networking system 120 in FIG. 1) retrieves the list of skills from each member profile.

In some example embodiments, for a particular skill in the list of possible skills, the social networking system (e.g., the social networking system 120 in FIG. 1) calculates (812) a total number of job listings requiring that particular skill and a total number of members who possess that particular skill. For example, the social networking system (e.g., the social networking system 120 in FIG. 1) tallies a total number of job listings that require each skill as the job listings are parsed. For example, if job listing A requires skill 34 and skill 67, the current counts for both skill 34 and skill 67 are incremented. Similarly, if job listing A is filled or otherwise removed from the database of job listings, the current tally for skill 34 and skill 67 are decremented. A similar process is used to keep a current tally of members that possess each skill.

In some example embodiments, the social networking system (e.g., the social networking system 120 in FIG. 1) determines (814) a skill gap value for the particular skill based on the total number of job listings requiring that particular skill and a total number of members who possess that particular skill.

In some example embodiments, the determining a skill gap value includes counting the total number of members who possess a particular skill and compares it to the number of job listings that require the skill. For each skill, a skill gap score is determined based on that comparison. In some example embodiments, the skill gap score is a comparison between the two numbers (e.g., subtract the number of members who have the skill from the number of job listings that require the skill). In other example embodiments, the skill gap score is a ratio of members who have the skill to job listings that require the skill.

In some example embodiments, each member is classified based on the likelihood that they are looking for a new job. For example, members who are unemployed are determined to have a high likelihood of looking for a new job and members who have very recently started a new job or educational program (e.g., within the last 3 months) will be determined to have a relatively low likelihood of looking for a new job. In other example embodiments, the likelihood is calculated based on the current length of employment, the member's specific history of job changes, and average job length in the specific role, industry, and location of the member.

In this case, a skill gap score is determined based on the number of members who have the particular skill that are likely to look for a new job (or be receptive to an offer for a new job) in the next three months (or other time period that is determined).

FIG. 8B is a flow diagram illustrating a method, in accordance with some example embodiments, for determining a skill gap score for skills based on member profiles and job postings stored at a social networking system (e.g., the social networking system 120 in FIG. 1). Each of the operations shown in FIG. 8B may correspond to instructions stored in a computer memory or computer-readable storage medium. Optional operations are indicated by dashed lines (e.g., boxes with dashed-line borders). In some embodiments, the method described in FIG. 8B is performed by the social networking system (e.g., the social networking system 120 in FIG. 1). However, the method described can also be performed by any other suitable configuration of electronic hardware. The method described in FIG. 8B continues from the steps shown in FIG. 8A.

In some embodiments the method is performed by a social networking system (e.g., the social networking system 120 in FIG. 1) including one or more processors and memory storing one or more programs for execution by the one or more processors.

In some example embodiments, the social networking system (e.g., the social networking system 120 in FIG. 1) associates (816) job listings with a particular geographic location. In some example embodiments, the social networking system (e.g., the social networking system 120 in FIG. 1) identifies location terms in the job listing while parsing the job listing and uses those terms to identify a particular location associated with the job listing. In other example embodiments, the location is received from the organization that submitted the job listing. In other example embodiments, the location associated with the organization that submitted the job listing is determined based on information about the location of the organizations offices, other employees, and so on (e.g., if the submitting corporation only has offices in State A, the job may be determined to be located in State A.)

In some example embodiments, the social networking system (e.g., the social networking system 120 in FIG. 1) associates (818) each member with a particular geographic location. As with the location associated with job listings, the location associated with the member can be determined from the information in the member's profile. For example, the member may have submitted their place of residence at the time the member registered for an account and then updated this information whenever the member's place of residence changed.

In some example embodiments, the social networking system (e.g., the social networking system 120 in FIG. 1) generates (820) geographic location-specific skill gap scores for a particular skill based on the number of job listings associated with the particular geographic location that require the particular skill and the number of members who are associated with the particular location that possess that particular skill.

A geographic location-specific skill score is generated in a manner similar to other skill gap scores, except that only members and job listings associated with the geographic location are used in determining the geographic location-specific skill gap.

In some example embodiments, determining a skill gap value for a particular skill includes subtracting the total number of members that possess a particular skill from the total number of job listings requiring that particular skill. In other example embodiments, determining a skill gap value for a particular skill includes calculating a ratio of the total number of members that possess a particular skill to the total number of job listings requiring that particular skill.

In some example embodiments, the social networking system (e.g., the social networking system 120 in FIG. 1) identifies (822) a list of skills associated with the first member based on a member profile of the first member. In some example embodiments, the social networking system (e.g., the social networking system 120 in FIG. 1) accesses the first member's member profile and retrieves the list of skills detailed therein. In other example embodiments, the social networking system (e.g., the social networking system 120 in FIG. 1) generates a list of skills based on data in the member's profile.

In some example embodiments, for a particular skill in the list of skills associated with the first member, the social networking system (e.g., the social networking system 120 in FIG. 1) identifies (824) a determined skill gap value associated with the particular skill. For example, if member A has skill D, skill E, and skill F, the social networking system (e.g., the social networking system 120 in FIG. 1) will determine, for one or all of them, a skill gap score associated with each one. The skill gap score is a measure that seeks to estimate the gap between job listings that require a particular skill (e.g., demand for members that have a particular skill) and the number of members that have the skill.

In some example embodiments, the social networking system (e.g., the social networking system 120 in FIG. 1) identifies one or more skills in the list of skills associated with the member to concentrate on. In some example embodiments, the skills are selected based on the rarity of the skills (e.g., skills that the fewest other members have), one or more key skills associated with the member's most recent job (e.g., based on a reference list associated jobs and job titles with key skills), and so on. In some example embodiments, the selected skills are based on the skills of the first member that have the highest skill rating (e.g., based on feedback from other members or other sources).

In some example embodiments, identifying a determined skill gap value associated with the particular skill further includes the social networking system (e.g., the social networking system 120 in FIG. 1) determining (826) a geographic location associated with the particular member. As noted above, the geographic location associated with the member is determined based on information located in the member's profile. For example, the member may have explicitly submitted a current geographic location when signing up for the social networking system (e.g., the social networking system 120 in FIG. 1).

FIG. 8C is a flow diagram illustrating a method, in accordance with some example embodiments, for determining a skill gap score for skills based on member profiles and job postings stored at a social networking system (e.g., the social networking system 120 in FIG. 1). Each of the operations shown in FIG. 8C may correspond to instructions stored in a computer memory or computer-readable storage medium. Optional operations are indicated by dashed lines (e.g., boxes with dashed-line borders). In some embodiments, the method described in FIG. 8C is performed by the social networking system (e.g., the social networking system 120 in FIG. 1). However, the method described can also be performed by any other suitable configuration of electronic hardware. The method described in FIG. 8C continues from the method shown in FIGS. 8A and 8B.

In some embodiments the method is performed by a social networking system (e.g., the social networking system 120 in FIG. 1) including one or more processors and memory storing one or more programs for execution by the one or more processors.

In some example embodiments, the social networking system (e.g., the social networking system 120 in FIG. 1) retrieves (828) a geographic location-specific skill gap score associated with the geographic location associated with the first member. Thus the social networking system (e.g., the social networking system 120 in FIG. 1) uses the geographic location determined to be associated with the first member to retrieve a geographic location-specific skill gap score for a particular skill that the first member has.

In some example embodiments, identifying a skill in the list of skills associated with the particular member with an associated skill gap value above a predetermined threshold further includes the social networking system (e.g., the social networking system 120 in FIG. 1) determining (830) whether the geographic location-specific skill gap score associated with the geographic location associated with the particular member exceeds a predetermined threshold.

In some example embodiments, for a particular skill in the list of skills associated with the particular member, the social networking system (e.g., the social networking system 120 in FIG. 1) identifies (832) a geographic area with a geographic-area-specific skill gap score for the particular skill above a predetermined threshold. In some example embodiments, the social networking system (e.g., the social networking system 120 in FIG. 1) identifies the geographic area with the biggest skill gap score for a particular skill. In this way, the social networking system (e.g., the social networking system 120 in FIG. 1) can identify geographic areas that have the largest demand for particular skills.

In some example embodiments, the social networking system (e.g., the social networking system 120 in FIG. 1) selects (834) from the identified geographic area one or more job listings that require the particular skill.

In some example embodiments, the social networking system (e.g., the social networking system 120 in FIG. 1) identifies (836) a job listing associated with an organization, wherein the job listing requires a list of skills.

FIG. 8D is a flow diagram illustrating a method, in accordance with some example embodiments, for determining a skill gap score for skills based on member profiles and job postings stored at a social networking system (e.g., the social networking system 120 in FIG. 1). Each of the operations shown in FIG. 8D may correspond to instructions stored in a computer memory or computer-readable storage medium. Optional operations are indicated by dashed lines (e.g., boxes with dashed-line borders). In some embodiments, the method described in FIG. 8D is performed by the social networking system (e.g., the social networking system 120 in FIG. 1). However, the method described can also be performed by any other suitable configuration of electronic hardware. The method described in FIG. 8D continues from the method shown in FIGS. 8A-8C.

In some embodiments the method is performed by a social networking system (e.g., the social networking system 120 in FIG. 1) including one or more processors and memory storing one or more programs for execution by the one or more processors.

For a particular skill in the list of skills, the social networking system (e.g., the social networking system 120 in FIG. 1) determines (838) whether a particular geographic location has a geographic location-specific skill gap for the particular skill above a predetermined threshold. In accordance with a determination that a particular geographic location has a geographic location-specific skill gap for the particular skill above a predetermined threshold, the social networking system (e.g., the social networking system 120 in FIG. 1) creates (840) a new job listing targeted at members associated with the particular location. For example, if job listing A is posted to target Area A, and the system determines that area B has a high supply of members with the skills required by job listing A, the system can automatically create a new listing that is more targeted to area B. For example, the listing can simply be reposted with a different target area listed or specifically sent as a recommendation to members who live in the identified area.

In other example embodiments, an organization can submit information about a job opening before creating a listing and receive a recommendation as to which geographic locations to target based on skill gap score.

In some example embodiments, the social networking system (e.g., the social networking system 120 in FIG. 1) determines (842) whether the particular skill in the list of skills has an associated skill gap value above a predetermined threshold. For example, if the skill gap score is a value ranging between 0 and 1 (with 0 being no skill gap and 1 being the maximum skill gap), the threshold for a notable skill gap may be set at 0.6. In a similar example, the social networking system (e.g., the social networking system 120 in FIG. 1) can measure which skill gap values have an effect on hiring (and the likelihood of a particular member with that skill gap getting a job) and set the threshold at a value equated with a particular likelihood that a member with that skill will be hired within a certain time (e.g., 75% change of being hired). In this example, the system analyzes past data to determine that 0.8 is the skill gap score associated with members who have the skill and are seeking to find a job within a certain time and sets the threshold at 0.8.

In accordance with a determination that the particular skill in the list of skills has an associated skill gap value above a predetermined threshold, the social networking system (e.g., the social networking system 120 in FIG. 1) retrieves (844) one or more job listings that require the particular skill.

FIG. 8E is a flow diagram illustrating a method, in accordance with some example embodiments, for determining a skill gap score for skills based on member profiles and job postings stored at a social networking system (e.g., the social networking system 120 in FIG. 1). Each of the operations shown in FIG. 8E may correspond to instructions stored in a computer memory or computer-readable storage medium. Optional operations are indicated by dashed lines (e.g., boxes with dashed-line borders). In some embodiments, the method described in FIG. 8E is performed by the social networking system (e.g., the social networking system 120 in FIG. 1). However, the method described can also be performed by any other suitable configuration of electronic hardware. The method described in FIG. 8E continues from the method shown in FIGS. 8A-8D.

In some embodiments the method is performed by a social networking system (e.g., the social networking system 120 in FIG. 1) including one or more processors and memory storing one or more programs for execution by the one or more processors.

In some example embodiments, the social networking system (e.g., the social networking system 120 in FIG. 1) transmits (846) the one or more job listings to the client device for display.

In some example embodiments, the social networking system (e.g., the social networking system 120 in FIG. 1) retrieves (848) a list of skill gap values from a predetermined time period that occurred in the past. For example, the predetermined time period could be one month ago, one year ago, five years ago, or any other such predetermined time period. In some example embodiments, the social networking system (e.g., the social networking system 120 in FIG. 1) compares (850) the list of skill gap values from a past time period to a current list of skill gap values to identify one or more skill gap trends. For example, if the skill gap score for skill A is higher now than one year ago, the social networking system (e.g., the social networking system 120 in FIG. 1) determines that the skill is becoming more popular.

In this manner, this disclosure provides [conclude with a brief summary of why this invention is novel/different from prior art technologies, and the benefit of the described invention].

### Software Architecture

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

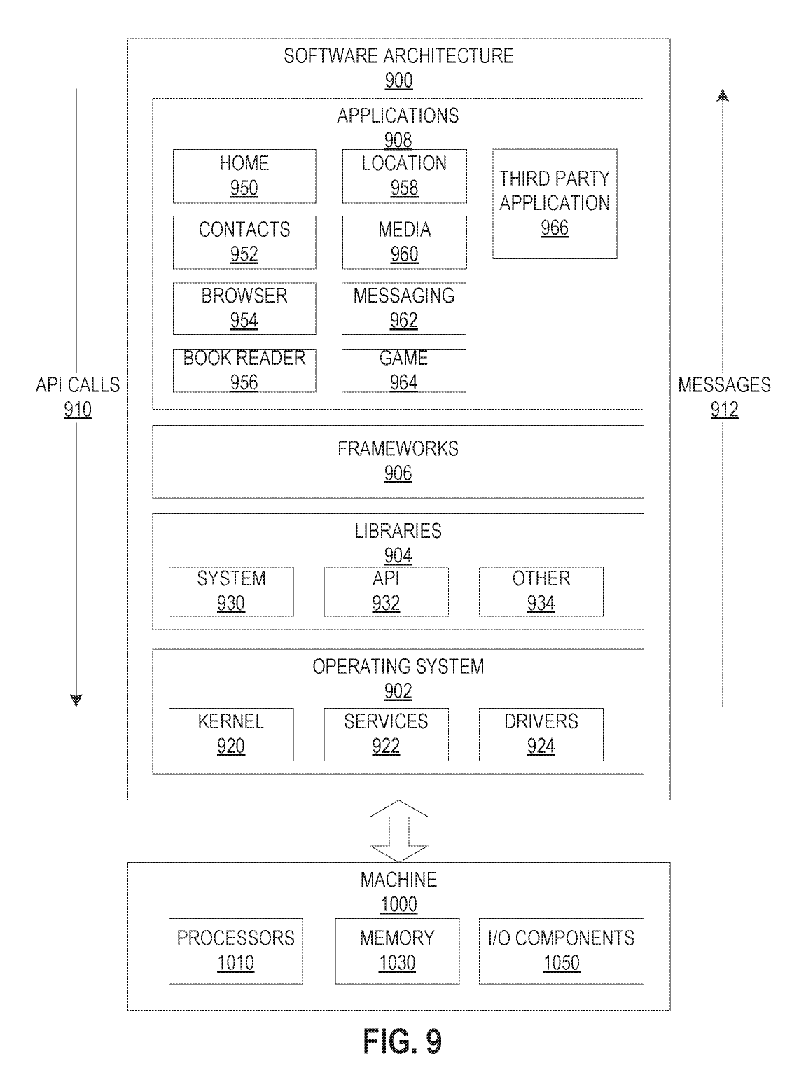

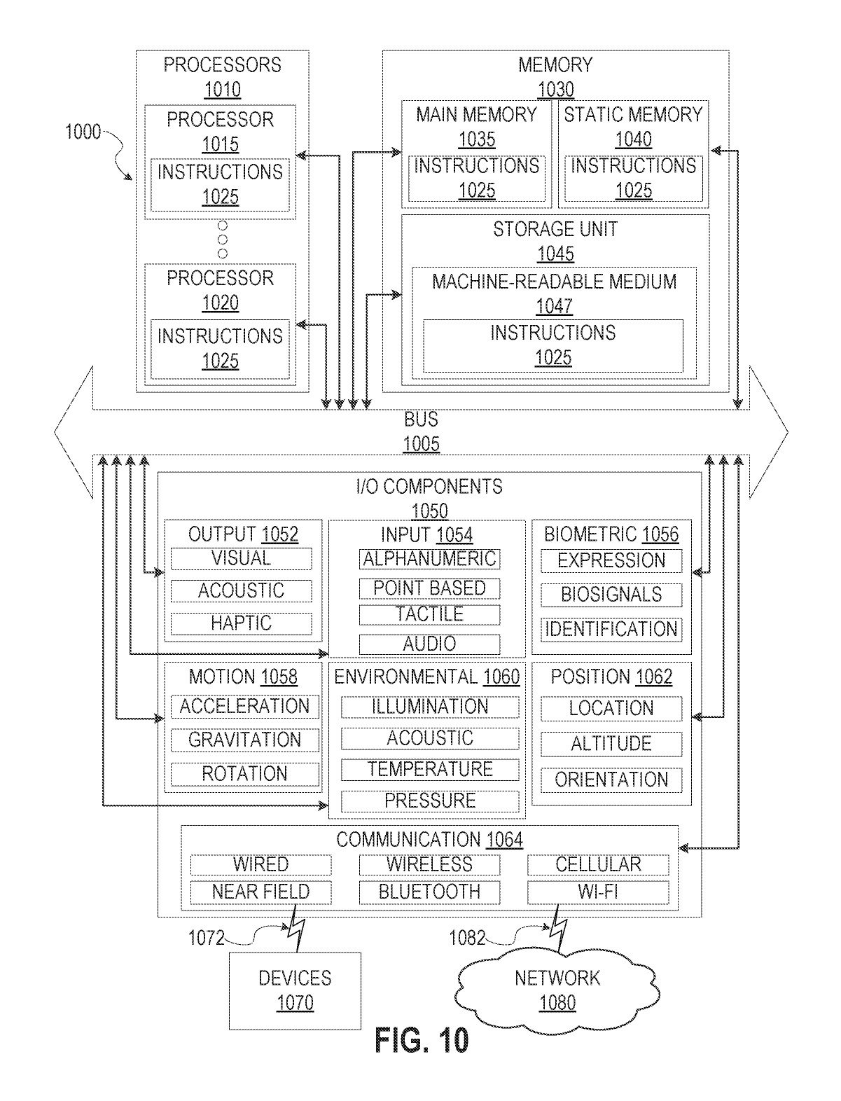

FIG. 9 is a block diagram illustrating an architecture of software 900, which may be installed on any one or more of the devices of FIG. 1. FIG. 9 is merely a non-limiting example of an architecture of software 900 and it will be appreciated that many other architectures may be implemented to facilitate the functionality described herein. The software 900 may be executing on hardware such as a machine 1000 of FIG. 10 that includes processors 1010, memory 1030, and I/O components 1050. In the example architecture of FIG. 9, the software 900 may be conceptualized as a stack of layers where each layer may provide particular functionality. For example, the software 900 may include layers such as an operating system 902, libraries 904, frameworks 906, and applications 908. Operationally, the applications 908 may invoke API calls 910 through the software stack and receive messages 912 in response to the API calls 910.

The operating system 902 may manage hardware resources and provide common services. The operating system 902 may include, for example, a kernel 920, services 922, and drivers 924. The kernel 920 may act as an abstraction layer between the hardware and the other software layers. For example, the kernel 920 may be responsible for memory management, processor management (e.g., scheduling), component management, networking, security settings, and so on. The services 922 may provide other common services for the other software layers. The drivers 924 may be responsible for controlling and/or interfacing with the underlying hardware. For instance, the drivers 924 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 904 may provide a low-level common infrastructure that may be utilized by the applications 908. The libraries 904 may include system libraries 930 (e.g., C standard library) that may provide functions such as memory allocation functions, string manipulation functions, mathematic functions, and the like. In addition, the libraries 904 may include API libraries 932 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 904 may also include a wide variety of other libraries 934 to provide many other APIs to the applications 908.

The frameworks 906 may provide a high-level common infrastructure that may be utilized by the applications 908. For example, the frameworks 906 may provide various graphical user interface (GUI) functions, high-level resource management, high-level location services, and so forth. The frameworks 906 may provide a broad spectrum of other APIs that may be utilized by the applications 908, some of which may be specific to a particular operating system 902 or platform.

The applications 908 include a home application 950, a contacts application 952, a browser application 954, a book reader application 956, a location application 958, a media application 960, a messaging application 962, a game application 964, and a broad assortment of other applications, such as a third-party application 966. In a specific example, the third-party application 966 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 966 may invoke the API calls 910 provided by the mobile operating system, such as the operating system 902, to facilitate functionality described herein.

### Example Machine Architecture and Machine-Readable Medium

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1025 (e.g., software 900, a program, an application, an applet, an app, or other executable code) for causing the machine 1000 to perform any one or more of the methodologies discussed herein may be executed. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but be not limited to, a server computer, a client computer, a PC, a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1025, sequentially or otherwise, that specify actions to be taken by the machine 1000. Further, while only a single machine 1000 is illustrated, the term “machine” shall also be taken to include a collection of machines 1000 that individually or jointly execute the instructions 1025 to perform any one or more of the methodologies discussed herein.

The machine 1000 may include processors 1010, memory 1030, and I/O components 1050, which may be configured to communicate with each other via a bus 1005. In an example embodiment, the processors 1010 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 1015 and a processor 1020, which may execute the instructions 1025. The term “processor” is intended to include multi-core processors 1010 that may comprise two or more independent processors 1015, 1020 (also referred to as “cores”) that may execute the instructions 1025 contemporaneously. Although FIG. 10 shows multiple processors 1010, the machine 1000 may include a single processor 1010 with a single core, a single processor 1010 with multiple cores (e.g., a multi-core processor), multiple processors 1010 with a single core, multiple processors 1010 with multiple cores, or any combination thereof.

The memory 1030 may include a main memory 1035, a static memory 1040, and a storage unit 1045 accessible to the processors 1010 via the bus 1005. The storage unit 1045 may include a machine-readable medium 1047 on which are stored the instructions 1025 embodying any one or more of the methodologies or functions described herein. The instructions 1025 may also reside, completely or at least partially, within the main memory 1035, within the static memory 1040, within at least one of the processors 1010 (e.g., within the processor's cache memory), or any suitable combination thereof, during execution thereof by the machine 1000. Accordingly, the main memory 1035, the static memory 1040, and the processors 1010 may be considered machine-readable media 1047.

As used herein, the term “memory” refers to a machine-readable medium 1047 able to store data temporarily or permanently and may be taken to include, but not be limited to, random-access memory (RAM), read-only memory (ROM), buffer memory, flash memory, and cache memory. While the machine-readable medium 1047 is shown, in an example embodiment, to be a single medium, the term “machine-readable medium” should be taken to include a single medium or multiple media (e.g., a centralized or distributed database, or associated caches and servers) able to store the instructions 1025. The term “machine-readable medium” shall also be taken to include any medium, or combination of multiple media, that is capable of storing instructions (e.g., instructions 1025) for execution by a machine (e.g., machine 1000), such that the instructions 1025, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 1050 may include a wide variety of components to receive input, provide and/or produce output, transmit information, exchange information, capture measurements, and so on. It will be appreciated that the I/O components 1050 may include many other components that are not shown in FIG. 10. In various example embodiments, the I/O components 1050 may include output components 1052 and/or input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 1050 may include biometric components 1056, motion components 1058, environmental components 1060, and/or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 1062 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 and/or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine 1000 and/or any of a wide variety of peripheral devices (e.g., a peripheral device coupled via a USB).

Moreover, the communication components 1064 may detect identifiers and/or include components operable to detect identifiers. For example, the communication components 1064 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 1080 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1025 may be transmitted and/or received over the network 1080 using a transmission medium via a network interface device (e.g., a network interface component included in the communication components 1064) and utilizing any one of a number of well-known transfer protocols (e.g., HTTP). Similarly, the instructions 1025 may be transmitted and/or received using a transmission medium via the coupling 1072 (e.g., a peer-to-peer coupling) to the devices 1070. The term “transmission medium” shall be taken to include any intangible medium that is capable of storing, encoding, or carrying the instructions 1025 for execution by the machine 1000, and includes digital or analog communications signals or other intangible media to facilitate communication of such software 900.

Furthermore, the machine-readable medium 1047 is non-transitory (in other words, not having any transitory signals) in that it does not embody a propagating signal. However, labeling the machine-readable medium 1047 as “non-transitory” should not be construed to mean that the medium is incapable of movement; the medium should be considered as being transportable from one physical location to another. Additionally, since the machine-readable medium 1047 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A computer-implemented method using at least one computer processor, the method comprising:
receiving a request for recommended job listings from a client device, wherein the request is associated with a first member;
accessing a plurality of job listings from a database;
parsing each of the job listings of the plurality of job listings to identify a list of skills required by each job listing;
accessing a plurality of member profiles, each member profile being associated with a particular member;
analyzing the plurality of member profiles to extract a list of skills from each member profile; and
for a particular skill in the list of skills:
calculating a first number of job listings requiring the particular skill and a first number of members who possess the particular skill; and
determining a skill gap value for the particular skill based on the first number of job listings requiring that particular skill and the first number of members who possess that particular skill.

2. The method of claim 1,
identifying a list of skills associated with the first member based on information in the member profile of the first member;
for a particular skill in the list of skills associated with the first member:
identifying a determined skill gap value associated with the particular skill, the determined skill gap value indicating the degree to which demand for a particular skill is unmet;
determining whether the particular skill in the list of skills associated with the first member has an associated skill gap value above a predetermined threshold;
in accordance with a determination that the particular skill in the list of skills associated with the first member has an associated skill gap value above a predetermined threshold, retrieving one or more job listings that require the particular skill; and
transmitting the one or more job listings to the client device for display.

3. The method of claim 1, wherein the job listings are submitted by organizations and stored in the database.

4. The method of claim 1, wherein determining a skill gap value for a particular skill includes subtracting the first number of members that possess the particular skill from the first number of job listings requiring that particular skill.

5. The method of claim 1, wherein determining a skill gap value for a particular skill includes calculating a ratio of the first number of members that possess the particular skill to the first number of job listings requiring that particular skill.

6. The method of claim 1, further comprising:
retrieving a list of skill gap values from a past time period; and
comparing the list of skill gap values from the past time period to a current list of skill gap values to identify one or more skill gap trends, at least one skill gap trend indicating increasing demand for a particular skill over time.

7. The method of claim 1, further comprising:
associating job listings with a particular geographic location;
associating each member with a particular geographic location; and
generating geographic location-specific skill gap scores for a particular skill based on the number of job listings associated with the particular geographic location that require the particular skill and the number of members who are associated with the particular geographic location that possess that particular skill.

8. The method of claim 7, wherein determining a skill gap value associated with the particular skill further includes:
determining a geographic location associated with the particular member; and
retrieving the geographic location-specific skill gap score associated with the geographic location associated with the particular member.

9. The method of claim 8, wherein determining whether the particular skill in the list of skills associated with the first member has an associated skill gap value above a predetermined threshold further includes determining whether the geographic location-specific skill gap score associated with the geographic location associated with the particular member exceeds a predetermined threshold.

10. The method of claim 7, further comprising:
for a particular skill in a list of skills associated with the particular member, identifying a geographic area with a geographic area-specific skill gap above a predetermined threshold; and
selecting one or more job listings from the identified geographic area that require the particular skill.

11. The method of claim 7, further comprising:
identifying a job opening associated with an organization, wherein the job opening requires a list of skills;
for a particular skill in the list of skills, determining whether a particular geographic location has a geographic location-specific skill gap for the particular skill above a predetermined threshold; and
in accordance with a determination that the particular geographic location has a geographic location-specific skill gap for the particular skill above the predetermined threshold, creating a job listing targeted at members associated with the particular geographic location.

12. A system comprising:
a computer-readable memory storing computer-executable instructions that, when executed by one or more hardware processors, configure the system to perform a plurality of operations, the operations comprising:
receiving a request for recommended job listings from a client device, wherein the request is associated with a first member;
accessing a plurality of job listings from a database;
parsing each of the job listings of the plurality of job listings to identify a list of skills required by each job listing;
accessing a plurality of member profiles, each member profile being associated with a particular member;
analyzing the plurality of member profiles to extract a list of skills from each member profile; and
for a particular skill in the list of skills:
calculating a first number of job listings requiring the particular skill and a first number of members who possess the particular skill; and
determining a skill gap value for the particular skill based on the first number of job listings requiring that particular skill and the first number of members who possess that particular skill.

13. The system of claim 12, the operations further comprising:
identifying a list of skills associated with the first member based on information in the member profile of the first member;
for a particular skill in the list of skills associated with the first member:
identifying a determined skill gap value associated with the particular skill, the determined skill gap value indicating the degree to which demand for a particular skill is unmet;
determining whether the particular skill in the list of skills associated with the first member has an associated skill gap value above a predetermined threshold;
in accordance with a determination that the particular skill in the list of skills associated with the first member has an associated skill gap value above a predetermined threshold, retrieving one or more job listings that require the particular skill; and
transmitting the one or more job listings to the client device for display.

14. The system of claim 12, wherein the job listings are submitted by organizations and stored in the database.

15. The system of claim 12, wherein determining a skill gap value for a particular skill includes subtracting the first number of members that possess the particular skill from the first number of job listings requiring that particular skill.

16. The system of claim 12, wherein determining a skill gap value for a particular skill includes calculating a ratio of the first number of members that possess the particular skill to the first number of job listings requiring that particular skill.

17. A non-transitory computer-readable storage medium storing instructions that, when executed by the one or more processors of a machine, cause the machine to perform operations comprising:
receiving a request for recommended job listings from a client device, wherein the request is associated with a first member;
accessing a plurality of job listings from a database;
parsing each of the job listings of the plurality of job listings to identify a list of skills required by each job listing;
accessing a plurality of member profiles, each member profile being associated with a particular member;
analyzing the plurality of member profiles to extract a list of skills from each member profile; and
for a particular skill in the list of skills:
calculating a first number of job listings requiring the particular skill and a first number of members who possess the particular skill; and
determining a skill gap value for the particular skill based on the first number of job listings requiring that particular skill and the first number of members who possess that particular skill.

18. The non-transitory computer-readable storage medium of claim 17, the operations further comprising:
identifying a list of skills associated with the first member based on information in the member profile of the first member;
for a particular skill in the list of skills associated with the first member:
identifying a determined skill gap value associated with the particular skill, the determined skill gap value indicating the degree to which demand for a particular skill is unmet;
determining whether the particular skill in the list of skills associated with the first member has an associated skill gap value above a predetermined threshold;
in accordance with a determination that the particular skill in the list of skills associated with the first member has an associated skill gap value above a predetermined threshold, retrieving one or more job listings that require the particular skill; and
transmitting the one or more job listings to the client device for display.

19. The non-transitory computer-readable storage medium of claim 17, wherein the job listings are submitted by organizations and stored in the database.

20. The non-transitory computer-readable storage medium of claim 17, wherein determining a skill gap value for a particular skill includes subtracting the first number of members that possess the particular skill from the first number of job listings requiring that particular skill.
